(19) United States
(12) Patent Application Publication
(10) Pub. No.: US 2006/0291247 A1
(43) Pub. Date: Dec. 28, 2006

(54) Light guide plate having curved grooves

(75) Inventors: Ko-Chia Kao, Chiu Ju Hsiang (TW); Jing-Huan Liao, Taoyuan City (TW); Chih-Kuang Chen, Kaohsiung (TW); Jyh-Haur Huang, Hsinyuan Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/242,682

(22) Filed: Oct. 4, 2005

(30) Foreign Application Priority Data
Jun. 8, 2005 (TW) 94118949

(51) Int. Cl. F21V 7/04

(52) U.S. Cl. 362/615

(57) ABSTRACT

A light guide plate has a substrate and a set of curved grooves. The set of curved grooves are on the substrate, and has a plurality of curves parallel to the substrate. By the curved grooves, the light guide plate can mitigate the Moiré effect induced by the conventional light guide plate and increase the intensity of emitting light.

### RELATED APPLICATIONS

The present application is based on, and claims priority from, Taiwan Application Serial Number 94118949, filed Jun. 8, 2005, the disclosure of which is hereby incorporated by reference herein in its entirety.

### BACKGROUND

1. Field of Invention

The present invention relates to a light source module. More particularly, the present invention relates to a light guide plate having curved grooves.

2. Description of Related Art

A backlight module is one of the key components for a liquid crystal display (LCD) panel. Since liquid crystals themselves do not emit light, the backlight module has to be used for providing a light source, whereby the LCD panel can show a normal image of uniform brightness.

FIG. 1 is a schematic diagram showing a conventional light guide plate. The light guide plate 100 comprises a substrate 102 and a set of curved grooves 104 formed on the substrate 102, and the set of curved grooves 104 is composed of a plurality of V-cut grooves 114 of straight lines. However, due to their periodic straight-lined structures, the Moiré effect are easily induced by the conventional V-cut grooves 114 together with liquid crystal (LC) pixels of an LCD, thus resulting in visual defects.

### SUMMARY

Hence, an aspect of the present invention is to provide a light guide plate, wherein the grooves thereof are curved in parallel on a substrate.

According to one preferred embodiment of the present invention, the light guide plate comprises a substrate and a first set of curved grooves, wherein the first set of curved grooves are formed on the substrate, and have a plurality of curves parallel to the substrate.

Moreover, the guide plate can selectively comprise a second set of curved grooves formed on the other side of the substrate opposite to the first set of curved grooves, and have a plurality of curves parallel to the substrate.

According to the other preferred embodiment of the present invention, the backlight module comprises a light source, a light guide plate, a prism sheet, and a holographic diffuser, wherein the prism sheet is disposed above the light guide plate, and the diffuser is disposed above the prism sheet. The light guide plate comprises a substrate and a first set of curved grooves, wherein the first set of curved grooves are formed on the substrate, and have a plurality of curves parallel to the substrate.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram showing a conventional light guide plate;

FIG. 2 is schematic diagram showing one preferred embodiment of the present invention;

FIGS. 3A to 3C are schematic diagrams showing several preferred embodiments regarding the light guide plate depicted in FIG. 2;

FIG. 4A is a schematic diagram showing curves in accordance with one preferred embodiment;

FIG. 4B is a schematic diagram showing curves in accordance with another preferred embodiment;

FIG. 5 is a schematic diagram showing curves in accordance with still another preferred embodiment for explaining a combination of different shapes;

FIG. 6 is a schematic diagram showing curves in accordance with still another preferred embodiment for explaining a combination of different arrangement phases;

FIG. 7 is a schematic diagram showing curves in accordance with still another preferred embodiment for explaining a combination of different shapes together with different arrangement phases; and

FIGS. 8A to 8C are schematic side views showing the curved grooves of preferred embodiments used as examples for explaining different types of curved grooves.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The present invention uses parallel curved grooves to replace straight grooves formed on the conventional light guide plate, thereby preventing the grooves on the light guide plate together with LC molecules from generating interference stripes which results in visual defects while users are in observation.

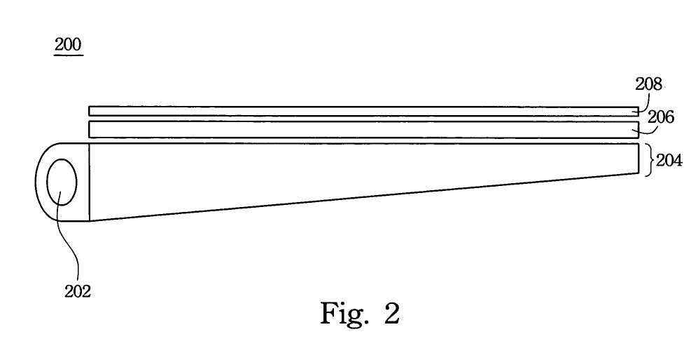

FIG. 2 is schematic diagram showing one preferred embodiment of the present invention. A backlight module 200 comprises a light source 202, a light guide plate 204, a prism sheet 206 and a diffuser 208. The light source 202 is connected to one end of the light guide plate 204 (such as a corner) or one side thereof. The prism sheet 206 is disposed above the light guide plate 204, and the diffuser 208 is disposed above the prism sheet 206. The light guide plate 204 comprises a substrate and at least one set of curved grooves formed on the substrate, wherein the set of curved grooves have a plurality of curves parallel to the substrate.

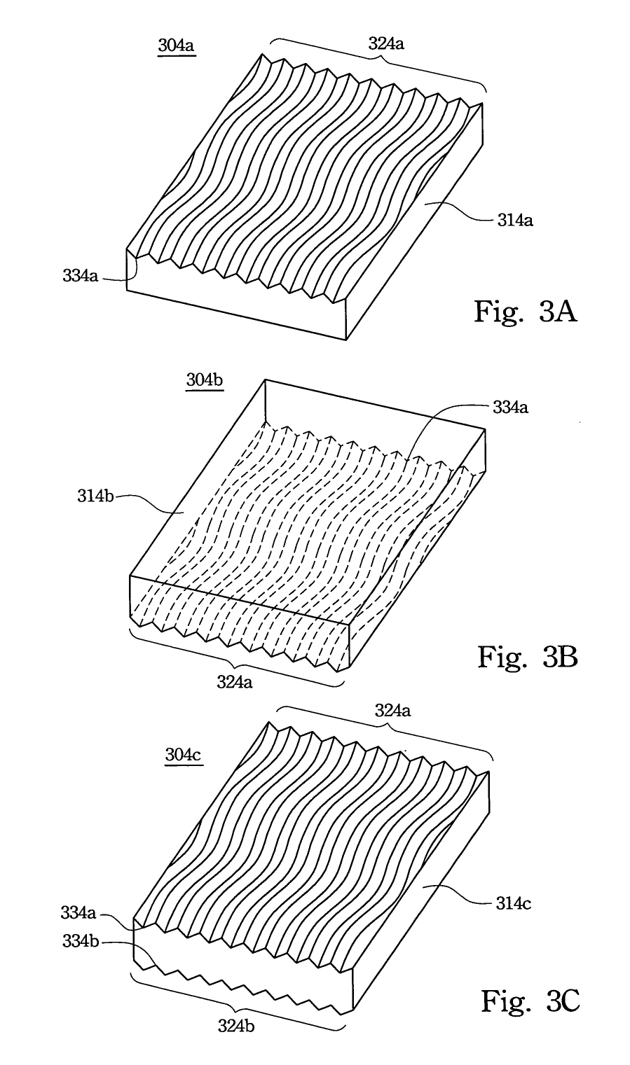

FIGS. 3A to 3C are schematic diagrams showing several preferred embodiments regarding the light guide plate 204 depicted in FIG. 2 for explaining the enablement variations of the curved grooves and their relative positions situated in the backlight module. The curved grooves can be disposed above the light guide plate, below the light guide plate or simultaneously above and below the light guide plate.

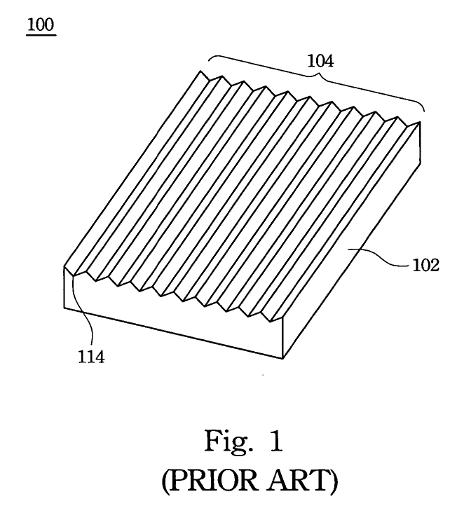

Such as shown in FIG. 3A, a light guide plate 304a of this embodiment comprises a substrate 314a and a first set of curved grooves 324a. The set of curved grooves 324a are formed on a surface of the substrate 314a adjacent to the prism sheet 206 (as shown in FIG. 2), and have a plurality of curves 334a parallel to the substrate 314a. In other words, the first set of curved grooves 324a are curved in parallel on the substrate 314a, and are different from the conventional V-cut grooves 114 of straight lines shown in FIG. 1A.

Alternatively, such as shown in FIG. 3B, the first set of curved grooves 324a of the light guide plate 304b in this embodiment are shown on a surface of the substrate 314b far way from the prism sheet 206 (as shown in FIG. 2), and also have a plurality of curves 334a parallel to the substrate 314b. Further, such as shown in FIG. 3C, besides the first set of curved grooves 324a having the curves 334a, the light guide plate 304c of this embodiment also can comprise a second set of curved grooves 324b formed on the other surface of the substrate 314c opposite to the first set of curved grooves 324a, wherein the second set of curved grooves 324b have a plurality of curves 334b parallel to the substrate 314c.

Hereinafter, various implementations of the curves of the curved grooves described above are discussed, such as the shapes of the curves, the distance between two adjacent peaks of each curve, the arrangement types relative to phases or shapes, and the types of the curved grooves, etc.

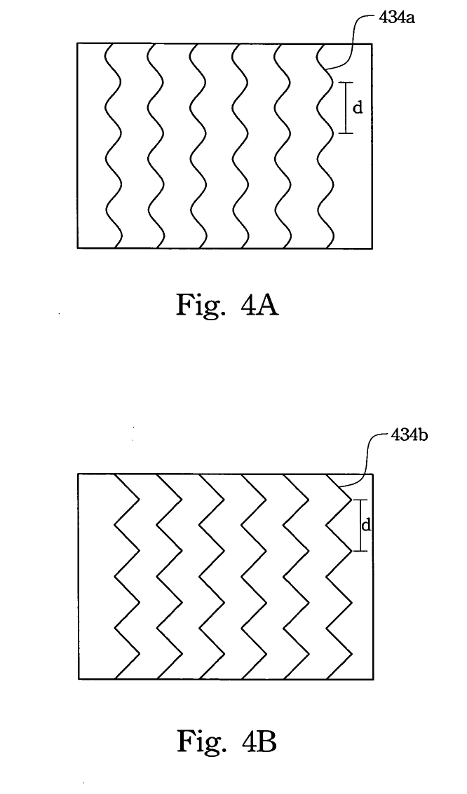

FIG. 4A is a schematic diagram showing curves in accordance with one preferred embodiment, wherein a plurality of curves 434a all are sine-wave lines, and the respective curves 434a have the same distance d between two adjacent peaks thereof, and have the same phase arrangement, i.e. the adjacent sine-wave curves 434a are in the form of peaks aligning with peaks and troughs aligning with troughs, thus having the same phase arrangement. FIG. 4B is a schematic diagram showing curves in accordance with another preferred embodiment, wherein a plurality of curves 434b all are N-shaped lines, and the respective curves 434b have the same distance d between two adjacent peaks thereof, and have the same phase arrangement, i.e. the adjacent N-shaped curves 434b are in the form of peaks aligning with peaks and troughs aligning with troughs, thus having the same phase arrangement.

Moreover, according to the embodiments of the present invention, the distance d of two adjacent peaks described above can be ranged between about 1 μm and about 100 μm, and preferably between about 5 μm and about 50 μm. However, the present invention is not limited to that all of the curves, which are disposed on the same substrate, must have the same distance d between two adjacent peaks thereof. Those who are skilled in the art may adjust the distance d between two adjacent peaks individually for the curves formed on different positions of the same substrate in accordance with the actual needs, thereby obtaining better optical effect.

Besides the aforementioned embodiments, the arrangement manners relative to the phases or shapes of the curves also can have other variations, such as a combination of different shapes, a combination of different arrangement phases or a combination of simultaneously different shapes and arrangement phases, etc.

FIG. 5 is a schematic diagram showing curves in accordance with still another preferred embodiment for explaining a combination of different shapes, wherein a plurality of curves 534a are sine-wave lines, and a plurality of curves 534b are N-shaped lines, wherein the respective curves 534a and 534b are alternately arranged periodically, and substantially have the same phase arrangement.

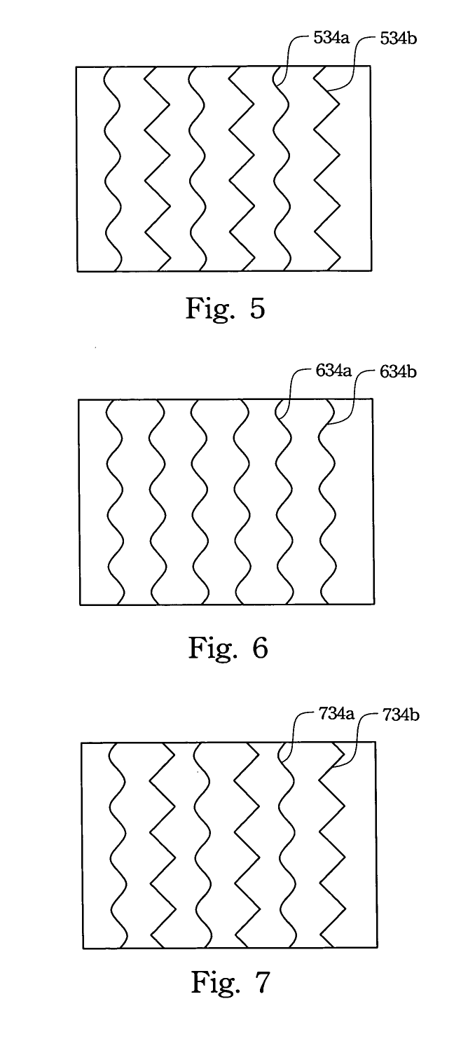

FIG. 6 is a schematic diagram showing curves in accordance with still another preferred embodiment for explaining a combination of different arrangement phases, wherein a plurality of curves 634a and a plurality of curves 634b all are sine-wave lines, and the phase arrangement of the curves 634a are exactly opposite to that of the curves 634b, and the respective curves 634a and 634b are alternately arranged periodically, i.e. between the adjacent curves 634a and 634b, peaks of one curve face troughs of the other curve, and thus both curves have the opposite phase arrangements. However, on the actual applications, the phases between the curves 634a and 634b do not need to be exactly opposite to each other, and can be adjusted to an arrangement having an appropriate phase difference.

FIG. 7 is a schematic diagram showing curves in accordance with still another preferred embodiment for explaining a combination of different shapes together with different arrangement phases, wherein a plurality of curves 734a are sine-wave lines, and a plurality of curves 734b are N-shaped lines, and the respective curves 734a and 734b are alternately arranged periodically, i.e. between the adjacent curves 734a and 734b, peaks of one curve face troughs of the other curve, and thus both curves have the opposite phase arrangements. However, on the actual applications, the phases between the curves 734a and 734b do not need to be exactly opposite to each other, and can be adjusted to an arrangement having an appropriate phase difference.

Moreover, the curves 534a and 534b shown in FIG. 5 have the same the distance d between two adjacent peaks thereof; the curves 634a and 634b shown in FIG. 6 have the same the distance d between two adjacent peaks thereof; and the curves 734a and 734b shown in FIG. 7 have the same the distance d between two adjacent peaks thereof. However, it is noted that: the distance d between two adjacent peaks can be actually different for the curves with different shapes disposed on the same substrate (such as shown in FIG. 5), for the curves with different phases disposed on the same substrate (such as shown in FIG. 6), or for the curves with different shapes and phases disposed on the same substrate (such as shown in FIG. 7), individually, so that the distance d between two adjacent peaks is not limited to the aforementioned preferred embodiments.

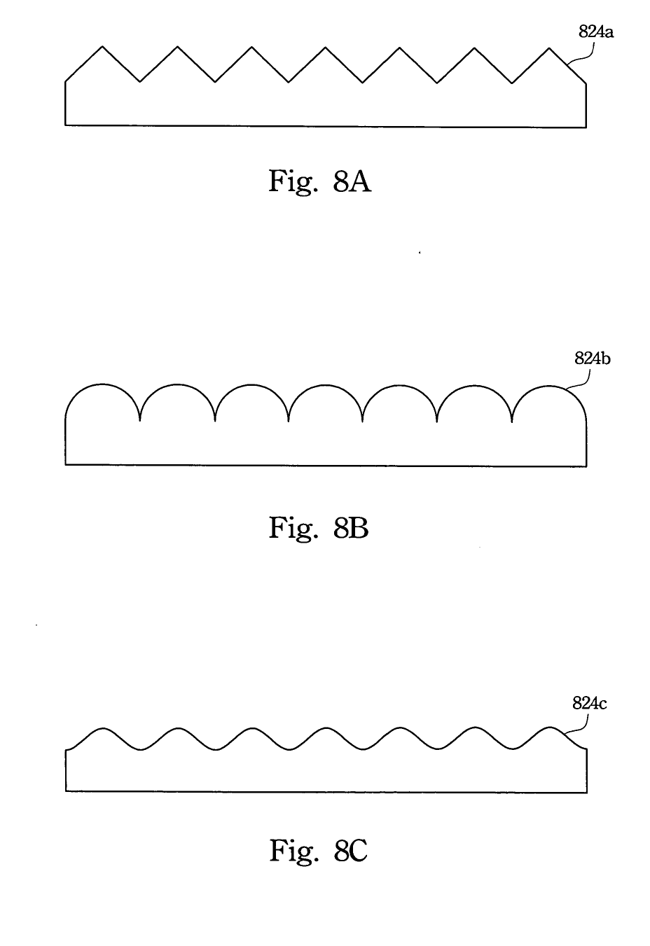

FIGS. 8A to 8C are schematic side views showing the curved grooves of preferred embodiments used as examples for explaining different types of curved grooves. As to the aforementioned curved grooves, the first set of curved grooves 324a and the second set of curved grooves 324b can selectively be V-cut grooves 824a (as shown in FIG. 8A); U-cut grooves 842b (as shown in FIG. 8B); wave-shaped grooves 824c (as shown in FIG. 8C), or other types of groove suitable for use in the light guide plate.

By using the curved grooves described above, the preferred embodiments of the present invention can prevent the curved grooves of the light guide plate together with LC molecules from generating interference stripes, so as to promote the brightness of a display panel. Such as the preferred embodiment shown in FIG. 4A, when the distance d between two adjacent peaks is about 5 μm, the brightness thereof (at the angle of 5 degrees) increases about 5% than that of the conventional light guide plate having the V-cut straight grooves. Hence, the present invention can mitigate the Moiré effect, and increase the brightness of emitting light, thus improving the display effect for a display panel.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light guide plate, comprising:
a substrate; and
a first set of curved grooves formed on the substrate, wherein the first set of curved grooves has a plurality of curves parallel to the substrate.

2. The light guide plate as claimed in claim 1, further comprising:
a second set of curved grooves formed on the other side of the substrate opposite to the first set of curved grooves, wherein the second set of curved grooves has a plurality of curves parallel to the substrate.

3. The light guide plate as claimed in claim 1, wherein the curves comprise sine-wave lines.

4. The light guide plate as claimed in claim 1, wherein the curves comprise N-shaped lines.

5. The light guide plate as claimed in claim 1, wherein the distance between two adjacent peaks of each curve is between about 1 μm and about 100 μm.

6. The light guide plate as claimed in claim 1, wherein the curves are in a periodically alternating arrangement.

7. The light guide plate as claimed in claim 1, wherein the curves are periodically arranged according to forms of the curves.

8. The light guide plate as claimed in claim 1, wherein the first set of curved grooves are V-cut grooves or U-cut grooves.

9. A backlight module, comprising:
a light source;
a light guide plate, the light source being connected to one end or one side of the light guide plate, wherein the light guide plate comprises:
a substrate; and
a first set of curved grooves formed on the substrate, wherein the first set of curved grooves has a plurality of curves parallel to the substrate;
a prism sheet disposed above the light guide plate; and
a holographic diffuser disposed above the prism sheet.

10. The backlight module as claimed in claim 9, further comprising:
a second set of curved grooves formed on the other side of the substrate opposite to the first set of curved grooves, wherein the second set of curved grooves has a plurality of curves parallel to the substrate.

11. The backlight module as claimed in claim 9, wherein the curves comprise sine-wave lines.

12. The backlight module as claimed in claim 9, wherein the curves comprise N-shaped lines.

13. The backlight module as claimed in claim 9, wherein the distance between two adjacent peaks of each curve is between about 1 μm and about 100 μm.

14. The backlight module as claimed in claim 9, wherein the curves are in a periodically alternating arrangement.

15. The backlight module as claimed in claim 9, wherein the curves are periodically arranged according to forms of the curves.

16. The backlight module as claimed in claim 9, wherein the first set of curved grooves are V-cut grooves or U-cut grooves.
